(19) United States
(12) Patent Application Publication
(10) Pub. No.: US 2006/0253539 A1
(43) Pub. Date: Nov. 9, 2006

(54) Realtime electronic communications system and method

(75) Inventors: Steven A. Casperson, Tampa, FL (US); Billy Wayne Crum, Indian Trail, NC (US); Brian J. McKeon, Indian Trail, NC (US)

Correspondence Address: SCHWARTZ LAW FIRM, P.C., 6100 FAIRVIEW ROAD, SUITE 11350, CHARLOTTE, NC, 28210, US

(73) Assignee: SIMPLE COM TOOLS, LLC, Tampa, FL (US)

(21) Appl. No.: 10/567,513

(22) PCT Filed: Aug. 9, 2004
(86) PCT No.: PCT/US04/26030

§ 371 Date: Jul. 17, 2006

Related U.S. Application Data
(60) Provisional application No. 60/493,270, filed on Aug. 7, 2003.

(51) Int. Cl. G06F 15/16

(52) U.S. Cl. 709/207

(57) ABSTRACT

A realtime electronic communications system utilizes an instant-messaging server. A first computer includes a first instant-messaging client. The first client is adapted for logging the first computer in to the server, and communicating to the server connecting information of the first computer. A second computer includes a second instant-messaging client. The second client is adapted for logging the second computer in to the server, and communicating to the server connecting information of the second computer. An external device is operatively connected to the second computer. Respective connecting information of the first and second computers is utilized for effecting realtime peer-to-peer communication between the first and second computers, whereby the first computer interfaces with the external device in realtime.

### TECHNICAL FIELD AND BACKGROUND OF THE INVENTION

This invention relates broadly to presence management technology, and more specifically to a realtime electronic communications system and method. The invention utilizes an industrial Internet appliance which supports secure, reliable serial and IP communications and Internet messaging applications in a single, integrated hardware device. The Internet appliance is a unique blend of serial and TCP/IP communications interfaces, digital and analog inputs, relays, and embedded applications. The invention provides a single device that can be seamlessly integrated into LAN, WAN, and WIRELESS projects. Its embedded applications provide quick and easy means of connecting serial devices to IP networks, Internet enabling legacy devices, or integrating remote devices with today's advanced 3G wireless data networks.

The fully integrated digital inputs, analog inputs, and relay allow use of one event to trigger another. For example, connect the analog input and relay, and you have a perfect solar battery monitor that can shut off equipment or start an electric generator. Connect a switch or motion sensor to one of several digital inputs and you have a turnkey security system that can trigger a siren or alarm; or an access control system to open a gate.

Along with the above, the invention can also send UDP packets, initiate TCP sessions, or even directly send email (SMTP) alerts based upon changes in digital inputs, analog values, or serial data streams. Packets and email messages can either stay on your Local LAN or be sent over the Internet or wireless networks to field personnel.

The invention is further applicable for connecting serial devices. For example, connect your RTU, PLC, or Data Logger to the RS232 or RS485 ports and select from a number of options, including: UDP, TCP, or SMTP data transport; Telnet access; and HTML data presentation.

The invention may be used in the field. Now remote serial or legacy data can be transported on any wireless network. Connect the Internet appliance to your wireless modem, and let its unique connection controls and embedded TCP/IP stack wirelessly enable your serial data devices. The invention sends email to any respondent located inside or outside the network. Alerts arrive on the LAN desktop via regularly used email clients, such as Microsoft Outlook, Lotus, and Netscape, or be sent to any person or device reachable via an email address including personal email services (AOL, MSN, Yahoo), Wireless PDAs, WAP or text message enabled cell phones and pagers.

### SUMMARY OF INVENTION

Therefore, it is an object of the invention to provide an industrial Internet appliance for use in a realtime electronic communications system and method.

It is another object of the invention to provide an industrial Internet appliance that has the unique ability to capture, store, and transport alarm events and serial data over IP networks via user-selectable TCP/IP network transport and messaging methods, such as UDP, TCP, FTP, SMTP, and Instant Message.

It is another object of the invention to provide an industrial Internet appliance useful in a wide variety of applications including, for example, stand-alone applications, access control/notification, contact closure notification, temperature notification, water level notification, solar battery monitoring, generator control, internetworking applications, ethernet to PPP gateway/router, 3G wireless connectivity, IP access to serial devices, RS485/RS232 conversion, e-mailing serial data streams, report by exception enabling, TCP/TELNET access to RS-232 and RS-485 devices over a LAN or WIRELESS IP network, UDP PAD functionality for both RS232 and RS485 device ports, LAN-to-WAN or LAN-to-WIRELESS connections via PPP over RS232 Modem port, LAN-to-WAN gateway functionality including DHCP, NAT, and Port Forwarding, network protocols: UDP, TCP, NTP, SNMP, DHCP, PPP, HTTP, FTP, SMTP & Telnet, and RS232 to RS485 interchange/conversion.

It is another object of the invention to provide an industrial Internet appliance which, as a stand-alone device, can trigger a relay upon change in status of digital inputs (contact closures).

It is another object of the invention to provide an industrial Internet appliance which, as a stand-alone device, can trigger a relay upon analog value changes (set points).

It is another object of the invention to provide an industrial Internet appliance which, when connected to a LAN or PPP connection, can update DNS hostname tables to reflect change in IP Address (dynamic DNS), send an email notification on a change in state of a digital input, send an email notification on a change in high or low analog values, and initiate outbound UDP packets or TCP sessions based upon either of the above.

It is another object of the invention to provide an industrial Internet appliance which, when connected to a terminal (RTU, PLC, or Logger), can send an e-mail upon arrival of serial data stream (serial data can be included in message), send UDP packets or initiate TCP sessions upon arrival of serial data stream, and monitor serial data and initiate e-mail, UDP or TCP when needed (Report By Exception).

It is another object of the invention to provide an industrial Internet appliance which is applicable for communicating, examining and/or controlling alarm, event, status, security, and presence information of inanimate devices to and from humans and/or other devices utilizing peer-to-peer Instant Messaging and Presence Protocol (IMPP) or Common Presence and Instant Messaging (CPIM).

It is another object of the invention to provide a communications system which utilizes a peer-to-peer network attachment method which provides device presence indication and event notification, configuration, status, and attached device access using Instant Messaging and Presence Protocol or Common Presence and Instant Messaging or other peer-to-peer messaging protocol.

It is another object of the invention to provide a communications system which utilizes a message notification method whereby the message notification is the configuration of code used to perform the creation and interpretation of messages for the purpose of communicating authorized parameters.

It is another object of the invention to provide a communications system which utilizes an instant messaging or peer-to-peer notification method for means of providing device presence indication.

It is another object of the invention to provide a communications system which utilizes a multi-mode graphical display of computer software icons as a means of providing device status indication including the status of the proscribed device and/or any attached devices.

It is another object of the invention to provide a communications system which utilizes instant messaging or peer-to-peer receipt and communication verification means.

It is another object of the invention to provide a communications system utilizing an indicator which indicates the presence of proscribed devices after sending or receiving instant messaging or peer-to-peer notifications.

It is another object of the invention to provide a communications system which utilizes a method to restrict unauthorized users from communicating to or receiving information or notifications from the Internet appliance without prior authorization.

It is another object of the invention to provide a communications system which utilizes security and instant messaging or peer-to-peer code recipient filtering and/or exclusion means.

It is another object of the invention a communications system which utilizes means to capture device alarm events and format event data into a message for transport to another device using IM.

It is another object of the invention to provide a communications system which utilizes a message formation process whereby device event triggers are converted to data and formatted into a instant messaging or peer-to-peer code to be transported to another device.

It is another object of the invention to provide a communications system which utilizes a method to receive device alarm event data from another device using IM.

It is another object of the invention to provide a communications system which utilizes a message receipt process whereby device event messages are received from another device, interpreted, and then acted upon or locally or which result in a message response.

It is another object of the invention to provide a communications system which utilizes a method to capture device alarm events and format event data into a message for transport to computer based messaging client software.

It is another object of the invention to provide a communications system which utilizes a message formation process whereby device event triggers and/or attached device generated data are converted and/or formatted into a instant messaging or peer-to-peer code to be transported to computer based messaging client software.

It is another object of the invention to provide a communications system which utilizes a method to receive device status requests and attached device access requests from a computer based messaging client software.

It is another object of the invention to provide a communications system which utilizes a message receipt process whereby device status and configuration requests and/or requests for attached device access originating from computer based messaging client software are received, interpreted, and then acted upon.

It is another object of the invention to provide a communications system which utilizes a method to encapsulate data into a message for transport using IM.

It is another object of the invention to provide a communications system which utilizes a protocol encapsulation and de-encapsulation technique, whereby the technique transmits the event data or data originating from an attached device via instant messaging or peer-to-peer code to computer based messaging client software or other said proscribed devices.

These and other objects of the present invention are achieved in the preferred embodiments disclosed below by providing a realtime electronic communications system which utilizes an instant-messaging server. A first computer includes a first instant-messaging client. The first client is adapted for logging the first computer in to the server, and communicating to the server connecting information of the first computer. A second computer includes a second instant-messaging client. The second client is adapted for logging the second computer in to the server, and communicating to the server connecting information of the second computer. An external device is operatively connected to the second computer. Means utilizing respective connecting information of the first and second computers are provided for effecting realtime peer-to-peer communication between the first and second computers, whereby the first computer interfaces with the external device in realtime.

The term “computer” is broadly defined herein as any programmable machine which can respond to a specific set of instructions, and/or execute a prerecorded list of instructions.

According to another preferred embodiment of the invention, the connecting information is an IP address and port number for each of the first and second computers.

According to another preferred embodiment of the invention, the first computer is a PC with a graphical user interface.

According to another preferred embodiment of the invention, a display monitor is connected to the PC.

According to another preferred embodiment of the invention, a status icon appears in an open window of the display monitor, and indicates a status of the external device in realtime.

According to another preferred embodiment of the invention, a text message appears in an open window of the display monitor, and indicates a status of the external device in realtime.

According to another preferred embodiment of the invention, means are provided for automatically communicating a status of the external device to the first computer upon a predetermined event identified by the second computer.

According to another preferred embodiment of the invention, the predetermined event identified by the second computer is selected from a group consisting of a change in digital inputs, a change in analog values, and arrival of a serial data stream.

According to another preferred embodiment of the invention, means are provided for effecting an automated response in a second external device connected to the first computer upon a predetermined event identified by the second computer. The second computer communicates occurrence of the event to the first computer in realtime.

According to another preferred embodiment of the invention, the predetermined event identified by the second computer is selected from a group consisting of a change in digital inputs, a change in analog values, and arrival of a serial data stream.

According to another preferred embodiment of the invention, the automated response includes means for actuating a switch operatively connected to the second external device.

According to another preferred embodiment of the invention, the external device is selected from a group consisting of a PC, data terminal, remote terminal unit, power line communications source, data logger, measurement gauge, and switching device.

According to another preferred embodiment of the invention, a wireless modem is operatively connected to at one of the first and second computers.

According to another preferred embodiment of the invention, the second computer has an RS-232 port.

According to another preferred embodiment of the invention, the second computer has an RS485 port.

According to another preferred embodiment of the invention, the instant-messaging server comprises an open source, XML-based platform which allows it to read addresses from different messaging clients.

According to another preferred embodiment of the invention, the first computer is a mobile node.

According to another preferred embodiment of the invention, the mobile node is selected from a group consisting of a cellular telephone, a laptop computer, a handheld computer, and a pager.

According to another preferred embodiment of the invention, the mobile node comprises technology selected from a group consisting of Cellular Digital Packet (CDP) Data, Code-Division Multiple Access (CDMA), General Packet Radio Service (GPRS), and Short Message Service (SMS).

According to another preferred embodiment of the invention, the instant-messaging server includes means for providing a multi-dimensional communications environment.

According to another preferred embodiment of the invention, the server communicates via a TCP/IP network.

According to another preferred embodiment of the invention, the first computer is a node on a local area network.

According to another preferred embodiment of the invention, the first computer is a node on a wide area network.

According to another preferred embodiment of the invention, the first computer is a mobile node on a wireless network.

In another embodiment, the invention is a computer adapted for incorporation in a realtime electronics communication system. The computer includes an instant-messaging client adapted for logging the computer in to an instant-messaging server, and communicating to the instant-messaging server connecting information of the computer. A communications interface is selected from a group consisting of RS-232, RS-422, RS-485, ethernet, 802.11, Bluetooth, USB, CANbus, and Fieldbus. A hardware interface is selected from a group consisting of a digital input, an analog input, and a relay output. The communications interface and the hardware interface are adapted for connecting an external device to the computer, such that the instant-messaging server establishes an interaction between the external device and a second computer including an instant-messaging client logged in to the instant-messaging server.

In yet another embodiment, the invention is a method for realtime electronic communication. The method includes the steps of operatively connecting an external device to a first computer, and effecting peer-to-peer communication between the first computer and a remote second computer. The second computer interfaces with the external device in realtime.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a perspective view of the Internet Appliance adapted for use in a realtime electronic communications system and method of the present invention;

FIG. 2 is a front view of the Internet Appliance;

FIG. 3 is a rear view of the Internet Appliance;

FIG. 4 is a schematic diagram illustrating how the present Internet Appliance incorporates in to the realtime electronic communications system and method;

FIG. 5 is a flow diagram demonstrating operation of the present communications system for External Devices connecting to inbound serial data ports;

FIG. 6 is a flow diagram demonstrating operation of the present communications system for External Devices connecting to the analog interface;

FIG. 7 is a flow diagram demonstrating operation of the present communications system for External Devices connecting to the digital interface;

FIG. 8 is a flow diagram demonstrating operation of the present communications system for External Devices connecting to the analog interface and generating a local contact closure response via a relay;

FIG. 9 is a flow diagram demonstrating operation of the present communications system for External Devices connecting to the digital interface and generating a local contact closure response via a relay;

FIG. 10 is a flow diagram demonstrating operation of the present communications system utilizing a timer-based relay trigger;

FIG. 11 is a flow diagram demonstrating the remote/local configuration utilities of the present communications system;

FIG. 12 is a screen shot illustrating various instant messaging icons appearing on an IM peer display screen; and

FIG. 13 is a screen shot showing examples of various text messages appearing on an IM peer display screen.

### DESCRIPTION OF THE PREFERRED EMBODIMENT AND BEST MODE

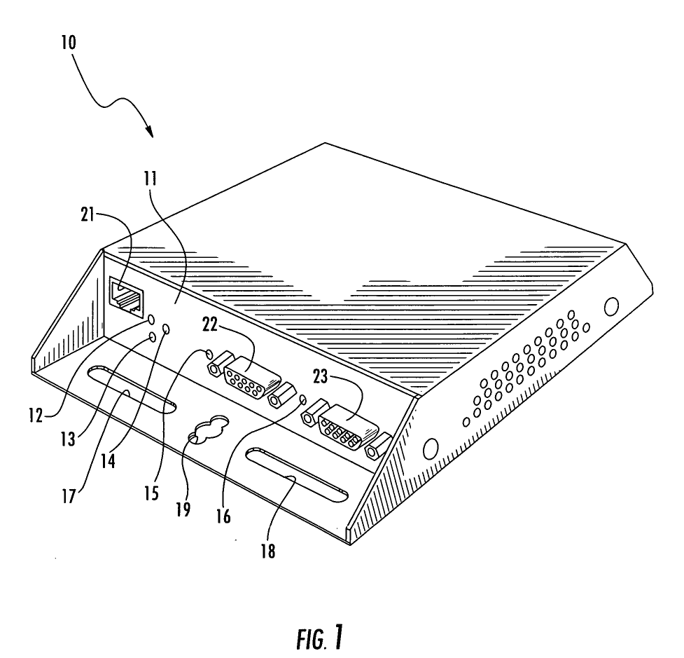

Referring now specifically to the drawings, an industrial internet appliance according to the present invention is illustrated in FIG. 1, and shown generally at reference numeral 10. The Internet Appliance is applicable for use in a realtime electronic communications system and method described below.

Referring to FIGS. 1, 2, and 3, the Internet Appliance 10 comprises a microprocessor encased in a compact rigid housing, certain embedded software, and various communication and hardware interfaces. A front panel 11 of the housing has a number of LEDs 12, 13, 14, 15, and 16 indicating, respectively, whether the appliance is currently powered on, whether the appliance is currently connected to an Ethernet network or device, whether the appliance is currently transmitting Ethernet traffic, whether the appliance is currently communicating with a serial device, and whether the appliance is currently engaged in an active PPP session. Preferably, the width dimension of the housing is less than 6 inches, the length dimension less than 8 inches, and the height dimension less than 2 inches. The rigid housing defines slotted and oval mounting holes 17, 18, and 19 designed for receiving appropriate fasteners to conveniently mount the Internet Appliance 10 to any sheet metal, wood, or plastic structure.

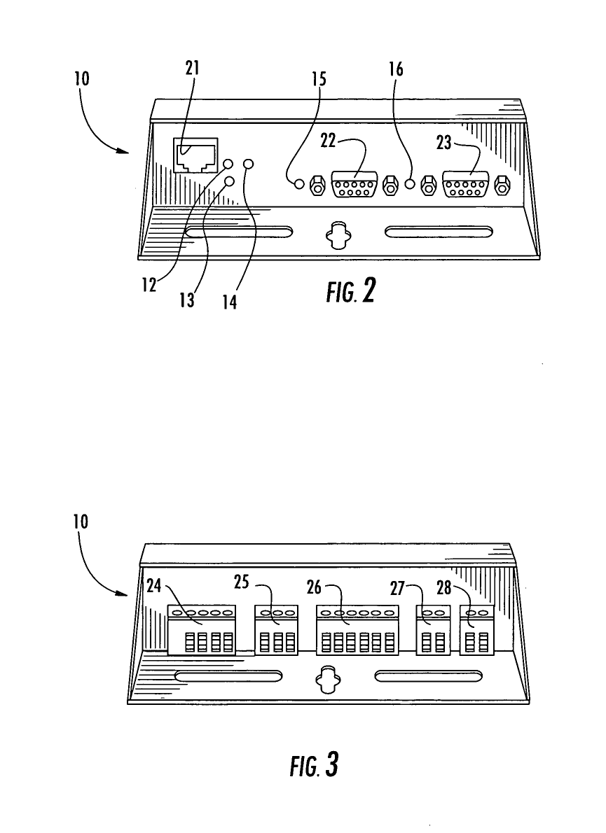

As best shown in FIGS. 2 and 3, the communication interfaces include an Ethernet port 21, a female DB9 RS-232 DCE port 22, a male DB9 RS-232 DTE port 23, and an RS-485 port 24. The Ethernet port 21 is used to connect to an LAN HUB or switch. The female RS-232 port 22 is used to connect to a computer or terminal. The male RS-232 port 23 is used to connect to a modem or DCE. The RS-485 port 24 supports 2 or 4-wire master or slave connections.

The hardware interfaces include relay outputs 25, digital inputs 26, analog inputs 27, and a power input 28. The relay interface 25 is used to connect an external device that a user desires to turn on and off. The digital interface 26 is used to connect simple contact closure switches or electronic pulses. The analog interface 27 is used to connect simple analog measurement gauges. The power interface 28 is used to connect to a 9-30 VDC power source.

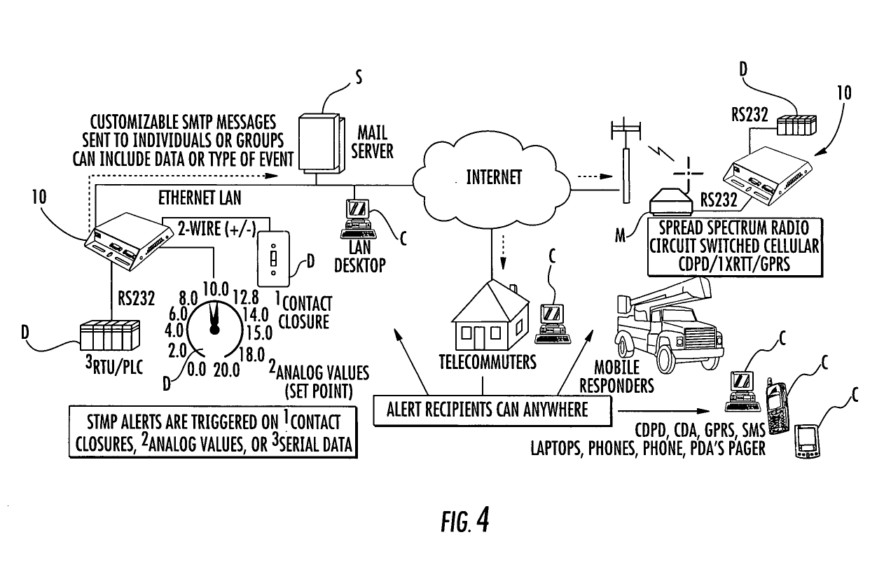

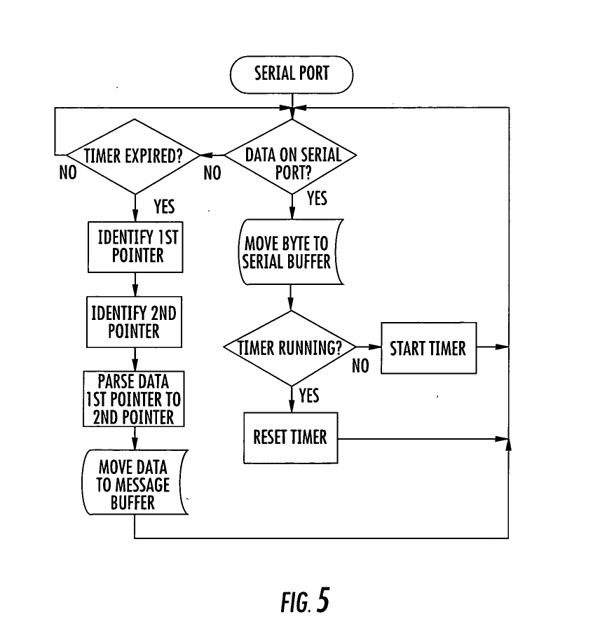

In the environment illustrated in FIG. 4, the Internet Appliance 10 connects to one or more of several various External Devices “D”, and utilizes standard Internet messaging software, a wireless or land-line modem “M”, Messaging Server “S”, and the Internet to effect peer-to-peer communication between the Internet Appliance 10 and a Remote Computer “C”. When connected, the Internet Appliance 10 is applicable for communicating, examining, and/or controlling alarm, event, status, security, and presence information of the External Devices “D” to and from users of the Remote Computer “C” and/or other messaging peers (not shown). The External Devices “D” may comprise a PC, data terminal, remote terminal unit, power line communications source, data logger, or the like. The Remote Computer “C” may be a standard PC utilizing appropriate Internet messaging software, a graphical user interface, and a connected display monitor. Alternatively, the Remote Computer “C” may be a second Internet Appliance or any other mobile node such as a cellular telephone, laptop computer, handheld computer, pager, or the like.

Data Communication Functions

In one application, the Internet Appliance monitors data input from the External Device, parses the data, and stores it to nonvolatile memory. Based on user-defined parameters, the Internet Appliance automatically forwards an assembled message to the Remote Computer via standard Internet messaging protocols-namely, FTP, UDP/TCP, SMTP, and Instant Messaging using Instant Messaging and Presence Protocol (IMPP) and Common Presence and Instant Messaging (CPIM).

The preferred communication is made in realtime using peer-to-peer or Instant Messaging (aka: ‘IM’) enabled through Instant Messaging and Presence Protocol (IMPP), Common Presence and Instant Messaging (CPIM), or similar IM protocols. An embedded IM client initiates and maintains a connection to the Messaging Server, and communicates to the Messaging Server the IP address and port number of the Internet Appliance. Likewise, an embedded IM client of the Remote Computer communicates the computer's connection information to the Messaging Server. The Messaging Server makes all connecting information available to the IM-connected peers which can then interface directly with each other in realtime. Examples of commercially available IMPP services include, but are not limited to MSN Messenger, Yahoo! Messenger, ICQ, AOL Instant Message (AIM), Yahoo Messenger, Jabber, and Groove Networks.

In the case of FTP, the Internet Appliance will log into an FTP server, authenticate using a username and password, open a specific directory or folder, transfer the data to the server using a user specified naming convention, and exit the server. In the case of UDP/TCP, the Internet Appliance will format the data into either a UDP or TCP packet, (with the serial data being the data payload in the packet) and transport the message to the Remote Computer or server. In the case of SMTP, the Internet Appliance will format the data into a SMTP message, connect to a SMTP Server and deliver the message to a single email recipient or multiple (groups) of email recipients at respective Remote Computers. Decisions on whether to send the message to a single recipient of group is based upon user defined variables.

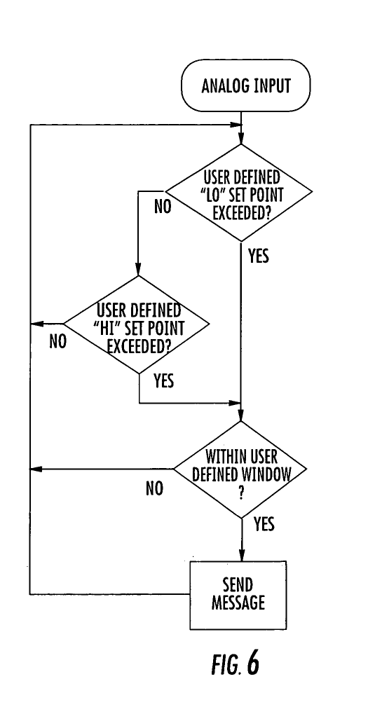

Referring to FIG. 5, for External Devices connecting to inbound serial data ports, system software instructs the Internet Appliance to constantly monitor the RS-232 and RS485 ports. When the first byte of data arrives, the Internet Appliance moves the byte into memory creating a buffer. The Internet Appliance also starts an inter-character timer. This timer is reset each time a byte arrives on the serial port. If the timer expires, the buffer is flagged as a data packet and the Internet Appliance performs one the following functions:

(a) A byte-by-byte comparison is made to an existing table of user defined byte arrays. This table represents the users desired data identifiers and serves as a serial string pointer; or

(b) The Internet Appliance will define the pointer by static byte position, as identified in the table of user defined byte arrays. The Internet Appliance continues to process the buffer to determine the location of a second pointer executing the same process as described above. On the identification of the second pointer location, the Internet Appliance moves the parsed data (data identified between the first and second pointer locations) into an allocated memory blocked defined for message building. This process is constantly executed moving parsed data into the messaging data block based upon the user-defined parameters located in the parsing table.

Support for the RS-485 port is accomplished in the same manner as that of RS-232. In addition, the RS-485 interface (being a multi-drop serial network) allows for the same applications to be supported across multiple serial devices, rather than one single serial device, as shown in FIG. 5.

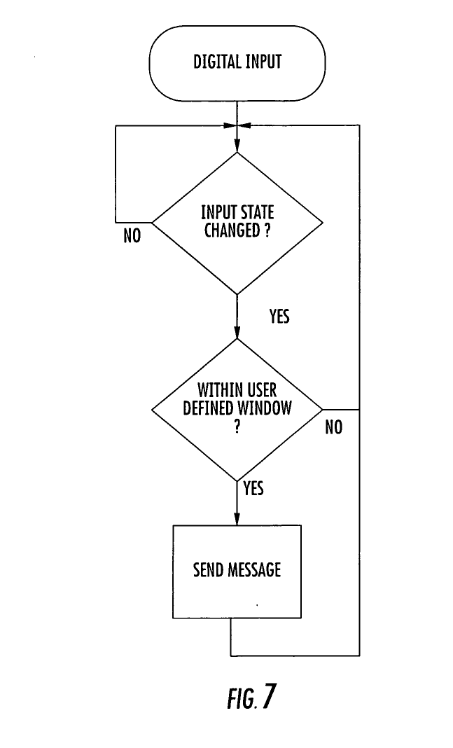

Referring to FIG. 6, in the case of an External Device connecting to the analog interface, the Internet Appliance monitors analog data values, stores values and/or changes (as defined by the user), and forwards a message to the Remote Computer via standard Internet messaging protocols. The detail of this functionality is discussed below.

The Internet Appliance constantly computes the current analog input value of the External Device and compares it to a user-defined “High Limit” and “Low Limit”. If the current value is greater than the “High Limit” or less-than the “Low Limit”, then the Internet Appliance moves the current analog value into a message buffer and will forward the assembled message to the Remote Computer in one of the various Internet messaging protocols mentioned above; preferably, Instant Messaging and Presence Protocol (IMPP) or Common Presence and Instant Messaging (CPIM).

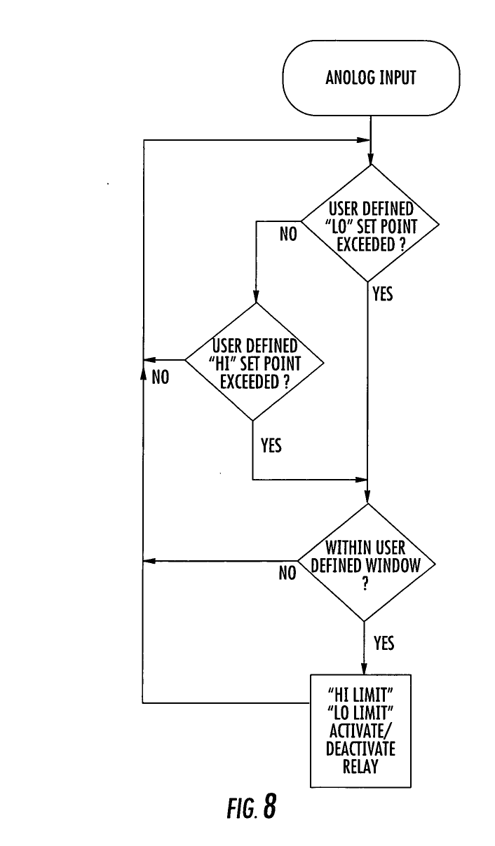

Referring to FIG. 7, in the case of an External Device connecting to the digital interface, the Internet Appliance constantly monitors the device to determine the state of the digital inputs. If the state changes and based upon the desired response selected (this is a user-selected defined response), the Internet Appliance reports the change to the Remote Computer in one of the various Internet messaging protocols mentioned above; including but not limited to, Instant Messaging and Presence Protocol (IMPP) or Common Presence and Instant Messaging (CPIM).

The Internet Appliance is further applicable for timer-based event message transport. In this case, the Internet Appliance monitors an internal Real Time Clock (RTC) and based on user-defined parameters, assembles the current status of the RS-232 and RS-485 ports, the analog and digital inputs, and the relay. The Internet Appliance stores the data to nonvolatile memory, assembles a data packet and message, and forwards the assembled message to the Remote Computer via standard Internet messaging protocols, as previously described.

All of the above communications functions are based upon the user defined reporting table, which supports all required parameters for reporting via Internet messaging protocols. The functions are also governed by a user-defined schedule based on time. These user-defined parameters determine the “window” of operation for this functionality.

The Internet Appliance can also monitor current IP addresses and report changes via dynamic domain name system updates to a domain name system server. The Domain Name System (DNS) is a distributed Internet directory service. DNS is used mostly to translate between domain names and IP addresses, and to control Internet server addressing for browsing and message delivery. Most Internet services rely on DNS to work properly.

The Internet Appliance has the ability to be assigned a local network or fully qualified internet hostname and domain, monitor the network connection for the currently assigned IP address, and dynamically report changes using the DNS protocol for dynamic updates to any DNS server. The Internet appliance can also be configured to report the currently assigned IP address or other network parameters to the DNS server based upon time, generating a “keep alive” in the form of a DNS report message.

Local Application Functions

In another application, the Internet Appliance monitors a status of the External Device, and based on user-defined parameters, effects one or a combination of the following:

(a) generates a local contact closure response via a relay;

(b) increments an internal counter, the value of which can be retrieved by the end-user at a later date and time; and

(c) initiates remote communications and/or tasks outlined above.

In the case of a relay trigger, the Internet Appliance monitors inbound data on the local RS-232 or RS-485 port, and based on user-defined parameters, generates a local contact closure response via a relay. Embedded system software instructs the Internet Appliance to constantly monitor the inbound serial data ports connecting to the External Device. When the first byte of data arrives, the Internet Appliance moves the byte into memory creating a buffer. The Internet Appliance also starts inter-character timer. This timer is reset every time a byte arrives on the serial port. If the timer expires, the buffer is flagged as a data packet and the Internet Appliance performs one of the following functions:

(a) If selected, a byte-by-byte comparison is made to an existing table of user-defined byte arrays. This table represent the users desired data identifiers and serves as a serial string pointer; or

(b) The Internet Appliance will define the pointer by static byte position identified in the table of user-defined byte arrays. The Internet Appliance continues to process the buffer to determine the location of a second pointer executing the same process as described above. On the identification of the second pointer location, the Internet Appliance compares the parsed data string to a user-defined table. If the string matches, the Internet Appliance will either open or close a local relay based on the desired behavior defined by the user.

Support for the RS-485 port is accomplished in the same manner as that of RS-232 In addition, the RS-485 interface (being a multi-drop serial network) allows for the same applications to be supported across multiple serial devices rather than one single serial device.

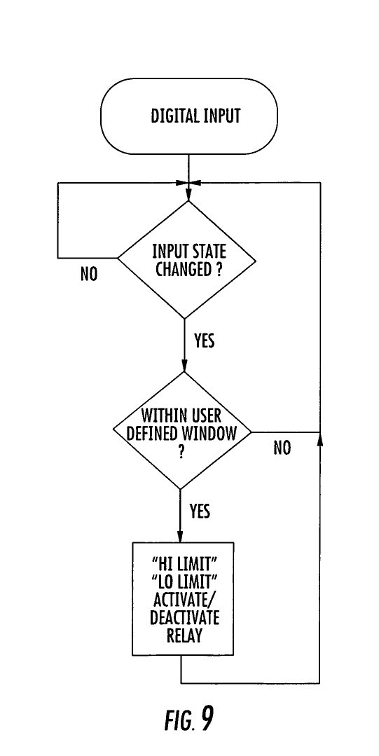

Referring to FIG. 8, for an External Device connecting to the analog interface, the Internet Appliance monitors analog data inputs, and based on user-defined parameters, generates a local contact closure response via a relay. Embedded system software instructs the Internet Appliance to constantly compute the current analog input value, and compares it to a user defined “High Limit” and “Low Limit”. If the current value is greater than the “High Limit” or less-than the “Low Limit”, then the Internet Appliance will either open or close a local relay based on the desired behavior defined by the user.

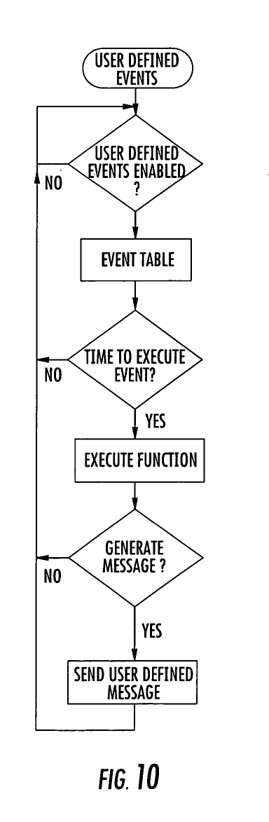

Referring to FIG. 9, for an External Device connecting to the digital interface, the Internet Appliance monitors digital inputs and based on user-defined parameters, generates a local contact closure response via a relay. Embedded system software instructs the Internet Appliance to constantly monitor the state of the digital inputs. If the state changes, and based upon the desired response selected (a user selected defined response), the Internet Appliance will either open or close a local relay.

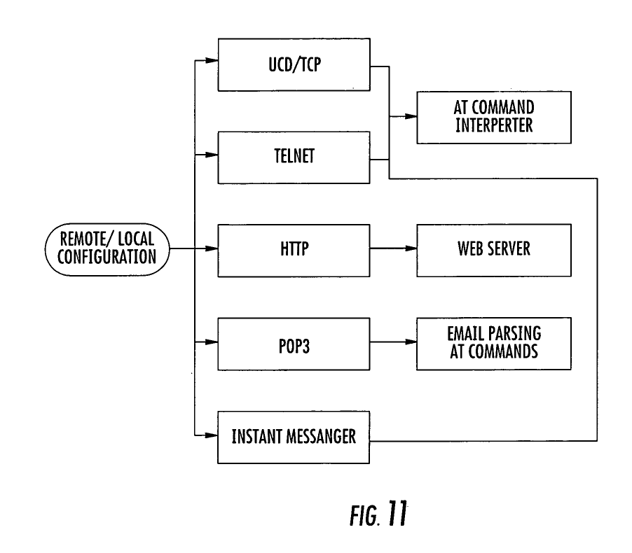

Referring to FIG. 10, in the case of a timer-based relay trigger, the Internet Appliance monitors a user-defined schedule based on time, and based on user-defined parameters, generates a local contact closure response via a relay. Embedded system software instructs the Internet Appliance to constantly monitor the internal Real Time Clock (RTC) and based on user-defined parameters, determines the “window” of operation for this functionality, and generates a local contact closure response via a relay.

Remote Configuration Functions

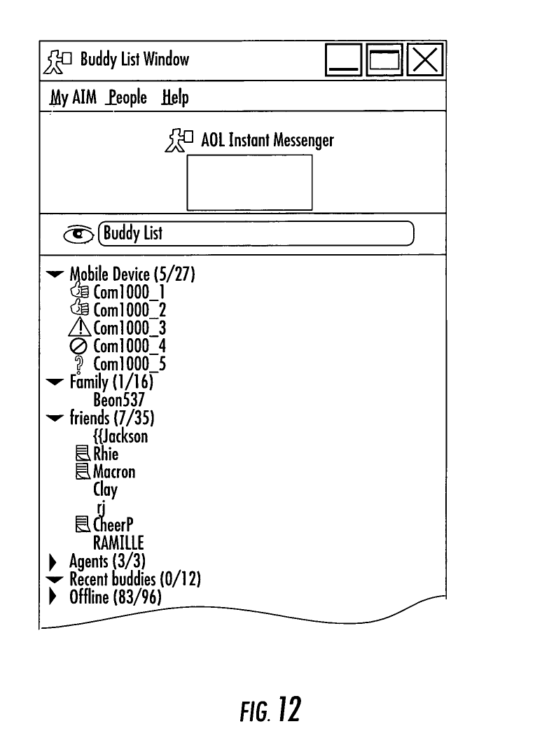

Referring to FIG. 11, the present Internet Appliance further enables:

(a) remote configuration of user defined parameters via the aforementioned Internet messaging protocols;

(b) remote connection to local external interfaces via the aforementioned Internet messaging protocols; and

(c) remote connection to local external interfaces generating a local response via a relay contact.

The Internet Appliance supports both local and remote configuration via, Terminal/Command-Line Interface, Telnet, UDP/TCP, SMTP/POP3, HTTP, and the previously described Instant Messaging protocols. The UDP/TCP allows connection based or connectionless configuration. The Internet Appliance parses inbound UDP data packets and determines if they are of “Configuration Type”. These data packets containing configuration parameters are used to configure the Internet Appliance. The same process is utilized for TCP packets. Telnet allows direct connection to the AT Command interpreter. When the Telnet connection is made to the user-defined “Teinet Configuration Port”, the Internet Appliance treats the connection as a local serial or Command-Line session. HTTP allows a web-based interface for status interrogation and configuration. The user uses a standard Internet Browser to browse to the appliance's Configuration Page. The user can then change selected appliance configuration parameters. SMTP/POP3 allows emails containing configuration commands to be sent to and received from the Internet Appliance for the purpose of causing the appliance to change its configuration based upon settings embedded in the email message. Instant Messenger (IM) allows access to the AT Command parser for the purpose of device status interrogation and reconfiguration. This functionality is similar to the implementation of Telnet. Both local and remote configuration can utilize user/password security available in the Internet Appliance.

The Internet Appliance further supports remote connections to local interfaces via Terminal/Command-Line Interface, Telnet, UDP/TCP, SMTP/POP3, HTTP, and the previously described Instant Messaging protocols. The user can define remote interfaces “binding” them to specific ports creating a connective path. For example, the Internet Appliance can be configured to support UDP connectivity on port 1234 for serial port 1. Thus, sending UDP packets to the Internet Appliance on port 1234 will result in the data being passed to serial port 1. And conversely, data arriving to serial port 1 will be formed into a packet and sent to the user defined remote IP Address/Port. The Internet Appliance supports TCP and Telnet in the same manner. SMTP/POP3 is supported by parsing the incoming email and forwarding the data payload to the respective user-defined local interface, and monitoring the interface for return data or acknowledgement and sending that content as the message body in a return email.

Instant Message support is similar in function and implementation to UDP, TCP, and Telnet. The Instant Message client embedded in the device receives an instruction/connection request in the form of an Instant Message from a remote computer or other IM client device. That instruction then connects the remote computer or IM device to the local interface. For example, the Internet Appliance can be configured to provide a connection for serial port 1 through the use of the Instant Message command “connect-serial”. Thus, sending all following Instant Messages to the Internet Appliance which will result in the data being passed to serial port 1 and then onward to any external device connected to that serial port. Conversely, data arriving to serial port 1 will be formed into a new Instant Message and sent back to the user initiating communications via that Instant Message clients defined remote IP Address/Port as provided by the Instant Messaging Server. This unique application and functionality would be best described as an “Instant Message Device Server” or “Instant Message Terminal Server”.

The Internet Appliance also provides the above remote functionality supporting local relay control. For example, the user can remotely “Close” (energize) the local relay via AT commands over Instant Message connectivity. The user opens a chat session with the Internet Appliance and sends the appliance the appropriate AT command to “Close” Relay1. The Internet Appliance then responds by energizing Relay1, and generating the “OK” response which is sent to the IM peer indication the requested command was completed.

### EXAMPLE I

### Remote Messaging Functions

The Internet Appliance is serially connected to a data logger monitoring the current pH level in a wastewater stream. The data logger is semi-intelligent as it records data but has no inherent communications capabilities. The Internet Appliance monitors the inbound data stream, parsing the data based upon user-defined parameters. If the data exceeds a “High” or “Low” set point, the Internet Appliance will perform one or more of the following functions based upon user-defined parameters:

(a) Change the Instant Message icon to reflect a change in state or value. FIG. 12 is a screen shot illustrating various messaging icons.

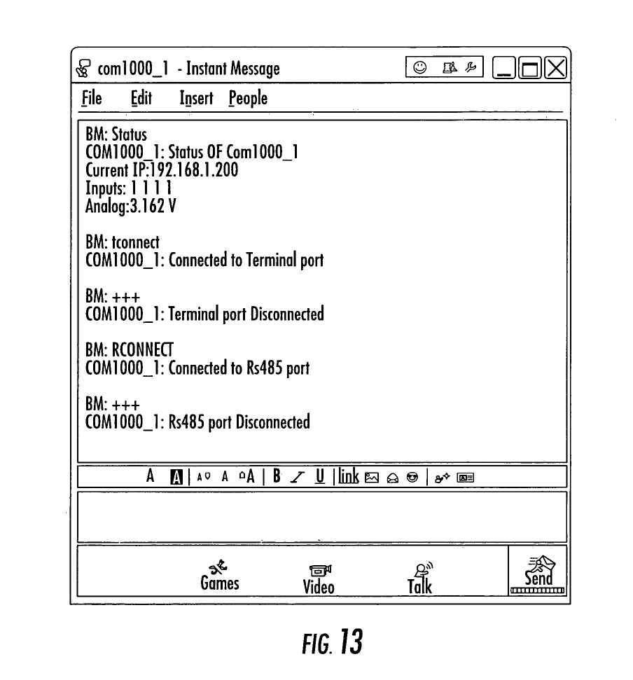

(b) Format a message and forward it to an Instant Message peer. FIG. 13 is a screen shot showing examples of various text messages forwarded to the IM peer.

(c) Format a message and forward it as an SMTP email alert, sending it to the user-defined email address.

The communications are intended to alert an upstream manufacturing plant of the condition of the wastewater system. The same tasks could also be used to notify the State EPA Incident Management System and alert the state inspector by sending a message to his/her cellular telephone for immediate notification.

### EXAMPLE II

### Local and Remote Alarm Functions

The Internet Appliance is interfaced to a float switch monitoring the level of a tank. If the level of the tank rises to a critical height, the contacts close, creating a change of state on a digital input of the Internet Appliance. The Internet Appliance captures the change and energizes (closes) a local relay. This causes one or more of several possible events to take place:

(a) Activate the starter on an external pump.

(b) Activate a switch for an audible alarm or siren to sound.

(c) Activate a switch for a light.

(d) Activate a telecommunications auto-dialer which initiates a remote phone call and message.

As the external pump lowers the tank level to a “normal/operational” level, the float switch “opens” causing a change in state on a digital input of the Internet Appliance. The Internet Appliance captures the change and de-energizes (opens) a local relay. This causes one or more of the following possible user-installed events to take place:

(a) Activate the starter on an external pump.

(b) Activate a switch for an audible alarm or siren to sound.

(c) Activate a switch for a light.

(d) Activate a telecommunications auto-dialer which initiates a remote phone call and message.

### EXAMPLE III

### Remote Management and Configuration

The Internet Appliance is interfaced to a remote data logger that is reporting temperature. The user has set analog input “High Level” and “Low Level” alarm set points. The user now wants to access the Internet Appliance remotely so as to change those set points.

The user chooses from a number of remote interface options that will allow access to the Internet Appliance and make the change. Those options would work in the following manner:

(a) DNS—the user accesses the device by referring to a unique name such as “remote1.simplecomtools.com”.

(b) HTTP—the user accesses the invention using a common Internet web browser and the current set point parameters are presented in HTML format. The set points can be modified from this same interface.

(c) FTP—the user accesses the invention using a common File Transfer Protocol (FTP) client. The user logs into the invention, and uploads a file containing new set point configurations.

(d) Teinet—the user accesses the invention remotely using a common terminal application, such as ProComm, HyperTerminal, or TeraTerm. The remote connection is made using TCP or Telnet protocols and requesting the connection to the remote unit using its IP Address or DNS hostname. Upon connection the user initiates a series of ‘AT Commands’ to set the desired “High Level” to “10” which results in an “OK” response from the invention and a “Low Level” to “3.5” which also results in an “OK” response. The user then writes the changes in the configuration to permanent memory with the “AT&W” command resulting in an “OK” response. The session is terminated.

(e) SMTP/POP-3 (Email)—using email, the user is able to make changes to the invention without directly accessing it. The user can send a formatted email message to an email account that corresponds to the device, such as remote1@simplecomtools.com. Periodically, the device will logon to an email server and using the POP-3 protocol, retrieve email messages. The invention parses the message components, extrapolates the commands relevant to changing the set point values, and executes and saves the necessary changes. The invention uses SMTP to send a return email (reply) to validate that the changes were received and executed.

(f) Instant Messaging (IMPP and CPIM)—the user will have a commonly used Internet Instant Messaging Protocol application graphical user interface (GUI) installed on its Remote Computer. Examples of commercial Instant Messaging services and/or GUI interfaces include, but are not limited to MSN Messenger, Yahoo! Messenger, ICQ, AOL Instant Message (AIM), Jabber, and Groove Networks. The Internet Appliance has a similar Instant Message client application embedded internally, and appears to other users on the Instant Message network as another peer user. A message connection is established using the Instant Message GUI of choice, and upon connection the user initiates a series of Commands to set the desired “High Level” to “10” and a “Low Level” to “3.5” which results in an acknowledgment from the Internet Appliance that the changes were made. The user then terminates the session.

An industrial internet appliance applicable for use in a realtime electronic communications system and method is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

We claim:

1. A realtime electronic communications system, comprising:
an instant-messaging server;
a first computer comprising a first instant-messaging client, said first client adapted for logging said first computer in to said server, and communicating to said server connecting information of said first computer;
a second computer comprising a second instant-messaging client, said second client adapted for logging said second computer in to said server and communicating to said server connecting information of said second computer;
an external device operatively connected to said second computer; and
means utilizing respective connecting information of said first and second computers for effecting realtime peer-to-peer communication between said first and second computers, whereby said first computer interfaces with said external device in realtime.

2. A realtime electronic communications system according to claim 1, wherein said connecting information comprises an IP address and port number for each of said first and second computers.

3. A realtime electronic communications system according to claim 1, wherein said first computer is a PC comprising a graphical user interface.

4. A realtime electronic communications system according to claim 3, and comprising a display monitor connected to said PC.

5. A realtime electronic communications system according to claim 4, and comprising a status icon appearing in an open window of said display monitor, and indicating a status of said external device in realtime.

6. A realtime electronic communications system according to claim 4, and comprising a text message appearing in an open window of said display monitor, and indicating a status of said external device in realtime.

7. A realtime electronic communications system according to claim 1, and comprising means for automatically communicating a status of said external device to said first computer upon a predetermined event identified by said second computer.

8. A realtime electronic communications system according to claim 7, wherein the predetermined event identified by said second computer is selected from a group consisting of a change in digital inputs, a change in analog values, and arrival of a serial data stream.

9. A realtime electronic communications system according to claim 1, and comprising means for effecting an automated response in a second external device connected to said first computer upon a predetermined event identified by said second computer, said second computer communicating occurrence of the event to said first computer in realtime.

10. A realtime electronic communications system according to claim 9, wherein the predetermined event identified by said second computer is selected from a group consisting of a change in digital inputs, a change in analog values, and arrival of a serial data stream.

11. A realtime electronic communications system according to claim 9, wherein said automated response comprises means for actuating a switch operatively connected to said second external device.

12. A realtime electronic communications system according to claim 1, wherein said external device is selected from a group consisting of a PC, programmable logic controller (PLC), remote terminal unit, data terminal, power line communications source, data logger, measurement gauge, and switching device.

13. A realtime electronic communications system according to claim 1, and comprising a wireless modem operatively connected to at one of said first and second computers.

14. A realtime electronic communications system according to claim 1, wherein said second computer comprises an RS-232 port.

15. A realtime electronic communications system according to claim 1, wherein said second computer comprises an RS-485 port.

16. A realtime electronic communications system according to claim 1, wherein said instant-messaging server comprises means for providing a multi-dimensional communications environment.

17. A realtime electronic communications system according to claim 16, wherein said server communicates via a TCP/IP network.

18. A realtime electronic communications system according to claim 1, wherein said first computer comprises a node on a local area network.

19. A realtime electronic communications system according to claim 1, wherein said first computer comprises a node on a wide area network.

20. A realtime electronic communications system according to claim 1, wherein said first computer comprises a mobile node on a wireless network.

21. A realtime electronic communications system according to claim 20, wherein said mobile node is selected from a group consisting of a cellular telephone, a laptop computer, a handheld computer, and a personal digital assistant (PDA).

22. A computer adapted for incorporating into a realtime electronics communication system, said computer comprising:
an instant-messaging client adapted for logging said computer in to an instant-messaging server, and communicating to the instant-messaging server connecting information of said computer;
a communications interface selected from a group consisting of RS-232, RS-422, RS-485, ethernet, 802.11, Bluetooth, USB, CANbus, and Fieldbus;
a hardware interface selected from a group consisting of a digital input, an analog input, and a relay output; and
said communications interface and said hardware interface adapted for connecting an external device to said computer, such that the instant-messaging server establishes realtime interaction between the external device and a second computer comprising an instant-messaging client logged in to the instant-messaging server.

23. A method for realtime electronic communication, said method comprising the steps of:
operatively connecting an external device to a first computer; and
effecting peer-to-peer instant-messaging communication between the first computer and a remote second computer, whereby the second computer interfaces with the external device in realtime.
